(19) United States
(12) Patent Application Publication
(10) Pub. No.: US 2021/0139726 A1
(43) Pub. Date: May 13, 2021

(54) INKJET INK AND IMAGE FORMING METHOD

(71) Applicant: KYOCERA Document Solutions Inc., Osaka-shi (JP)

(72) Inventor: Seishi OJIMA, Osaka-shi (JP)

(21) Appl. No.: 17/094,879

(22) Filed: Nov. 11, 2020

(30) Foreign Application Priority Data
Nov. 13, 2019 (JP) 2019-205497

(51) Int. Cl. C09D 11/328; C08G 63/688; C08G 63/672

(52) U.S. Cl. CPC C09D 11/328; C09D 11/34; C08G 63/672; C08G 63/6886

(57) ABSTRACT

The composite particles contained in an inkjet ink are particles of a composite of a polyester resin having a sulfur atom-containing polar group and a dye. The polyester resin is non-crystalline. The polyester resin has a first repeating unit derived from a polyvalent carboxylic acid having the sulfur atom-containing polar group, a second repeating unit derived from a polyvalent carboxylic acid having no sulfur atom-containing polar group, and a third repeating unit derived from a polyhydric alcohol. The content percentage of the first repeating unit relative to a total amount of the first repeating unit and the second repeating unit is 1 to 10 mol %. The content percentage of the polyester resin relative to the composite particles is 50% by mass or more and less than 100% by mass.

This application is based on and claims the benefit of priority from Japanese Patent application No. 2019-205497 filed on Nov. 13, 2019, which is incorporated by reference in its entirety.

### BACKGROUND

The present disclosure relates to inkjet inks.

An ink for digital printing is being studied for printing an image on a textile product such as a cloth by using an inkjet recording apparatus. For example, an inkjet hot melt ink which is a solid type ink and contains a dye and a water-soluble substance which is solid at room temperature for holding the dye in the ink has been proposed SUMMARY

The inkjet ink according to the present disclosure contains an aqueous medium and composite particles. The composite particles are particles of a composite of a polyester resin having a sulfur atom-containing polar group and a dye. The polyester resin is non-crystalline. The polyester resin has a first repeating unit derived from a polyvalent carboxylic acid having the sulfur atom-containing polar group, a second repeating unit derived from a polyvalent carboxylic acid having no sulfur atom-containing polar group, and a third repeating unit derived from a polyhydric alcohol. A content percentage of the first repeating unit relative to a total amount of the first repeating unit and the second repeating unit is 1 mol % or more and 10 mol % or less. A content percentage of the polyester resin relative to the composite particles is 50% by mass or more and less than 100% by mass.

### BRIEF DESCRIPTION OF THE DRAWINGS

FIG. 1 is a diagram illustrating an example of a configuration of an inkjet recording apparatus used in an image forming method according to a second embodiment of the present disclosure; and

FIG. 2 is a diagram for explaining a discharge step of the image forming method according to the second embodiment of the present disclosure.

### DETAILED DESCRIPTION

First, meanings of terms used in the present specification and measurement methods will be described. A compound and a derivative thereof may be collectively referred to by adding “-based” before a compound name. When the name of a polymer is referred by adding “-based” before a compound name, it means that the repeating unit of the polymer is derived from the compound or a derivative thereof. Unless otherwise specified, the acid value is a value measured in accordance with “JIS (Japanese Industrial Standard) K0070-1992”. Unless otherwise specified, the softening point (Tm) is a value measured using a capillary rheometer (“CFT 500D” manufactured by Shimadzu Corporation). The meanings of the terms used in the present specification and the measurement method have been described above. Next, embodiments of the present disclosure will be described.

### First Embodiment: Inkjet Ink

A first embodiment of the present disclosure relates to an inkjet ink (hereinafter, referred to as an ink). The ink of the first embodiment can be used, for example, as an ink for digital textile printing for printing an image on a textile product such as cloth using an inkjet recording apparatus. Digital textile printing has advantages over screen printing and rotary screen printing in that a step of removing a sizing agent is unnecessary and that dyeing wastewater can be reduced. In addition, digital textile printing has an advantage that printing can be performed in a small lot, and an advantage that waste liquid generated when a color to be dyed is changed is not generated, as compared with a tip dyeing method and a dip dyeing method for dyeing a large amount of fibers.

The ink of the first embodiment contains an aqueous medium and composite particles. The ink of the first embodiment is an aqueous ink containing the aqueous medium. Because the ink contains the composite particles, the ink having excellent dispersibility and discharge stability is obtained, and the friction fastness of an image formed using the ink is also improved. Hereinafter, the composite particles and the aqueous medium will be described.

### <Composite Particles>

The composite particles are particles of a composite of a polyester resin having a sulfur atom-containing polar group and a dye. The composite particles are, for example, dispersed (for example, emulsion-dispersed) in an aqueous medium. When the ink contains the composite particles, the following advantages are obtained.

When the ink containing the composite particles lands on a recording medium (for example, a textile product such as a polyester fabric or a cotton fabric) the recording medium and the composite particles adhere to each other via the polyester resin in the composite particles. As a result, the friction fastness of the formed image is improved

Since the polyester resin in the composite particles has the sulfur atom-containing polar group, appropriate hydrophilicity is imparted to the composite particles. As a result, the composite particles are satisfactorily emulsified and dispersed in the aqueous medium, and an ink having excellent dispersibility is obtained

Although the composite particles have appropriate hydrophilicity as described above, they also have appropriate hydrophobicity to the extent that they are not dissolved in an aqueous medium. Therefore, it is possible to prevent the polyester resin in the composite particles from being dissolved in the aqueous medium, adhering to the inside of the nozzles of the recording head included in the inkjet recording apparatus, and solidifying due to drying. As a result, clogging of the nozzles can be suppressed, and ink can be stably discharged from the nozzles.

In addition, in a case where the ink containing the composite particles lands on the recording medium and is subjected to the heat treatment, the composite particles are also plastically deformed along with the plastic deformation of the polyester resin on the recording medium. Since the plastically deformed composite particles spread on the surface of the recording medium, an image having a high image density can be printed even when a small amount of ink is used. In addition, unlike bleeding of the dye that spreads along the fibers of the recording medium due to a capillary phenomenon, the dyed area is widened due to plastic deformation of the composite particles, and thus an image printed using the ink containing the composite particles becomes clear. The advantages obtained by the ink containing the composite particles have been described above.

A volume median diameter (D₅₀) of the composite particles is preferably 20 nm or more and 300 nm or less, and more preferably 100 nm or more and 150 nm or less. When Do of the composite particles is 300 nm or less, the composite particles are suitably emulsified and dispersed in the aqueous medium, and the ink having excellent dispersion stability is obtained. As a result, a viscosity of the ink is stabilized without increasing. When the Da, of the composite particles is 300 nm or less, the composite particles contained in the ink are less likely to aggregate, and clogging of the nozzles of the recording head is further suppressed. In addition, a color developability of the formed image is also improved. D₅₀ of the composite particles can be adjusted, for example, by changing the stirring conditions (more specifically, the stirring speed, the stirring time, the presence or absence of a neutralizing agent such as an amine, and the like) in a composite particles preparation step described below, D₅₀ of the composite particles can also be adjusted, for example, by changing the type of the aqueous medium.

### (Polyester Resin Constituting Composite Particles)

The polyester resin constituting the composite particles is non-crystalline. The crystalline polyester resin is hardly dyed with a dye. On the other hand, the dye tends to more sufficiently penetrate into the non-crystalline region of the non-crystalline polyester resin than into the crystalline region. This is because the crystalline region is dense and hard to soften, but the non-crystalline region softens with an increase in temperature to weaken the entanglement of the resin chains, so that the dye easily permeates. Therefore, the non-crystalline region of the non-crystalline polyester resin is dyed with the dye, and the non-crystalline polyester resin and the dye are favorably complexed. The non-crystallinity of the polyester resin can be confirmed by, for example, differential scanning calorimetry (DSC). That is, when the polyester resin has a glass transition point (Tg) but does not have a clear melting point (Mp), the polyester resin is determined to be non-crystalline. When the polyester resin has a glass transition point (Tg) and a melting point (Mp), the polyester resin is determined to be crystalline.

In order to suppress unevenness of the formed image, the dye is preferably uniformly dispersed in the polyester resin in the composite particles. The non-crystalline region included in the polyester resin is easily dyed by a dye. For this reason, when the non-crystalline regions are uniformly disposed in the polyester resin, it is easy to obtain composite particles in which the dye is uniformly dispersed in the polyester resin.

As described above, the polyester resin constituting the composite particles has a sulfur atom-containing polar group. The polyester resin has a first repeating unit, a second repeating unit, and a third repeating unit. The first repeating unit is a repeating unit derived from a polyvalent carboxylic acid having a sulfur atom-containing polar group. The second repeating unit is a repeating unit derived from a polyvalent carboxylic acid having no sulfur atom-containing polar group. The third repeating unit is a repeating unit derived from a polyhydric alcohol.

The polyester resin is obtained by condensation polymerization of a first monomer, a second monomer, and a third monomer. That is, the polyester resin is a condensation polymer of the first monomer, the second monomer, and the third monomer. The first monomer is a polyvalent carboxylic acid having a sulfur atom-containing polar group. The second monomer is a polyvalent carboxylic acid having no sulfur atom-containing polar group. The third monomer is a polyhydric alcohol. By the condensation polymerization, the first repeating unit, second repeating unit, and third repeating unit are formed from the first second, and third monomers, respectively. That is, the first repeating unit, second repeating unit, and third repeating unit are a repeating unit derived from a first monomer, a repeating unit derived from a second monomer, and a repeating unit derived from a third monomer, respectively. The first monomer, second monomer, and third monomer may be contained in the polyester resin may be one type or two or more types, respectively.

When the first monomer is “A”, the repeating unit derived from the first monomer, which is the first repeating unit, is “a repeating unit derived from A”. Therefore, the description of the first monomer also serves as the description of the first repeating unit. For example, when 5-sulfoisophthalic acid is described as an example of the first monomer, a repeating unit derived from 5-sulfoisophthalic acid is also deemed to have been described as an example of the first repeating unit. Similarly, the description of the example of the second monomer and the example of the third monomer also serves as the description of the example of the second repeating unit and the example of the third repeating unit, respectively.

The content of the first repeating unit in the total amount (total amount of substance) of the first repeating unit and the second repeating unit is 1 mol % or more and 10 mol % or less. Hereinafter, the “content of the first repeating unit in the total amount of the first repeating unit and the second repeating unit” may be referred to as a “first repeating unit ratio”.

The sulfur-atom-containing polar group contained in the first repeating unit imparts appropriate hydrophilicity to the polyester resin. However, when the ratio of the first repeating unit is less than 1 mol %, the number of sulfur-atom-containing polar groups decreases, and the hydrophilicity of the polyester resin decreases. As a result of the decreased hydrophilicity, the composite particles containing the polyester resin are less likely to be emulsified and dispersed in the aqueous medium, and the dispersibility of the ink is decreased. In addition, as a result of the decreased hydrophilicity, it may be difficult to form composite particles by emulsification in the aqueous medium.

On the other hand, when the first repeating unit ratio exceeds 10 mol %, the hydrophilicity of the polyester resins becomes too high, and the polyester resin in the composite particles are dissolved in the aqueous medium. The dissolved polyester resin adheres to the inside of a nozzle of a recording head included in the inkjet recording apparatus, and is dried and solidified. As a result, the nozzle is clogged and the discharge stability of the ink from the nozzle decreases. In addition, the polyester resin may be dissolved in the aqueous medium during the production of the ink, and thus it may be difficult to form composite particles. In addition, since the hydrophilicity of the polyester resin becomes too high, the water resistance of the image printed using the ink containing the composite particles decreases.

In order to obtain an ink which is excellent in dispersibility and discharge stability and is excellent in friction fastness of a formed image, the first repeating unit ratio is preferably 3 mol % or more and 10 mol % or less, more preferably 5 mol % or more and 10 mol % or less, and still more preferably 7 mol % or more and 10 mol % or less

The first repeating unit ratio can be changed by, for example, changing the addition amount of the first monomer and the addition amount of the second monomer when the polyester resin is subjected to condensation polymerization. The first repeating unit ratio can be measured, for example, by analyzing the polyester resin using a nuclear magnetic resonance apparatus (NMR) to obtain a ratio between a peak characteristic of the first repeating unit and a peak characteristic of the second repeating unit

Hereinafter, the first repeating unit will be described. As the sulfur atom-containing polar group contained in the first repeating unit, for example, a sulfonic acid group or a metal salt of a sulfonic acid group is preferable. The metal salt of a sulfonic acid group is preferably an alkali metal salt of a sulfonic acid group, and more preferably a sodium salt, a potassium salt, or a lithium salt of a sulfonic acid group.

Examples of the first monomer for forming the first repeating unit include a divalent carboxylic acid having a sulfur atom-containing polar group, and more specifically, an aromatic divalent carboxylic acid having a sulfur atom-containing polar group. The aromatic divalent carboxylic acids having the sulfur atom-containing polar groups include, for example, 5-sulfoisophthalic acid, 4-sulfophthalate, 2-sulfoterephthalic acid, 3,5-dicarbomethoxybenzensulfonic acid, 4-sulfonaphthalene-2, 7-dicarboxylic acid, and 5-(4-sulfophenoxy) isophthalic acid, and the metal salts thereof. As the metal salts, alkali metal salts are preferable, and sodium salts, potassium salts, or lithium salts are more preferable.

When the sulfur atom-containing polar group of the first monomer is in the form of a metal salt, specific examples of such the first monomer include sodium 5-sulfoisophthalate, potassium 5-sulfoisophthalate, sodium 2-sulfoterephthalate, potassium 2-sulfoterephthalate, sodium 4-sulfophthalate, potassium 4-sulfophthalate, lithium 3,5-dicarbomethoxybenzenesulfonate, sodium 3.5-dicarbomethoxybenzenesulfonate, and potassium 3,5-dicarbomethoxybenzenesulfonate.

The first monomer is preferably at least one of 5-sulfoisophthalic acid, 4-sulfophthalic acid, 3,5-dicarbomethoxybenzenesulfonic acid, and alkali metal salts thereof, more preferably at least one of sodium 5-sulfoisophthalic acid, sodium 4-sulfophthalic acid, and sodium 3,5-dicarbomethoxybenzenesulfonic acid, and even more preferably sodium 5-sulfoisophthalic acid. The repeating unit derived from sodium 5-sulfoisophthalic acid, which is the first repeating unit, is represented by the following chemical formula (1).

[chemical structure]

Next, the second repeating unit will be described. Examples of the second monomer for forming the second repeating unit include an aromatic divalent carboxylic acid having no sulfur atom-containing polar group, an aliphatic divalent carboxylic acid having no sulfur atom-containing polar group, an alicyclic divalent carboxylic acid having no sulfur atom-containing polar group, and a three or more valent carboxylic acid having no sulfur atom-containing polar group.

Examples of the aromatic divalent carboxylic acid having no sulfur atom-containing polar group include terephthalic acid, isophthalic acid, naphthalenedicarboxylic acid (for example, 1,5-naphthalenedicarboxylic acid and 2,6-naphthalenedicarboxylic acid), benzylmalonic acid, 4,4′-dicarboxydiphenyl ether, diphenic acid, and phenylenediacrylic acid.

Examples of the divalent aliphatic carboxylic acid having no sulfur atom-containing polar group include malonic acid, dimethylmalonic acid, succinic acid, glutaric acid, adipic acid, trimethyladipic acid, pimelic acid, 2,2-dimethylglutaric acid, azelaic acid, sebacic acid, dodecanedicarboxylic acid, fumaric acid, maleic acid, itaconic acid, thiodipropionic acid diglycolic acid, mesaconic acid; and citraconic acid.

Examples of the alicyclic divalent carboxylic acid having no sulfur atom-containing polar group include 1,3-cyclopentanedicarboxylic acid, 1,2-cyclohexanedicarboxylic acid, 1,3-cyclopentanedicarboxylic acid, 1,4-cyclohexanedicarboxylic acid, 2,5-norbornanedicarboxylic acid, and adamantanedicarboxylic acid.

Examples of the three or more valent carboxylic acid having no sulfur atom-containing polar group include trimellitic acid, trimesic acid, adamantanetricarboxylic acid, and pyromellitic acid

The second monomer may be an alkyl ester of the carboxylic acid exemplified as the second monomer. The alkyl ester is preferably an alkyl ester having 1 or more to 6 or less carbon atoms, more preferably an alkyl ester having 1 or more to 3 or less carbon atoms, and still more preferably a methyl ester.

The second monomer is preferably at least one type of compound of an aromatic divalent carboxylic acid having no sulfur atom-containing polar group and an alkyl ester of the above mentioned acid. The second monomer is more preferably at least one type of compound of terephthalic acid, isophthalic acid, naphthalenedicarboxylic acid, diphenic acid, 4,4′-dicarboxydiphenyl ether, and alkyl esters of these acids. The second monomer is more preferably at least one type of compound of terephthalic acid, isophthalic acid, and naphthalenedicarboxylic acid, and alkyl esters of these acids. The second monomer is further more preferably at least two types of compounds of terephthalic acid, isophthalic acid, and naphthalenedicarboxylic acid, and alkyl esters of these acids.

Both the repeating unit derived from terephthalic acid and the repeating unit derived from terephthalic acid alkyl ester, which are the second repeating unit, are represented by the following Chemical Formula (2A). Both the repeating unit derived from isophthalic acid and the repeating unit derived from isophthalic acid alkyl ester, which are the second repeating unit, are represented by the following Chemical formula (2B). Both the repeating unit derived from naphthalenedicarboxylic acid and the repeating unit derived from naphthalenedicarboxylic acid alkyl ester, which are the second repeating units, are preferably represented by the following Chemical Formula (2C), and more preferably represented by Chemical Formula (2D).

[chemical structure]

Next, the third repeating unit will be described. Examples of the third monomer for forming the third repeating unit include aliphatic polyhydric alcohols, alicyclic polyhydric alcohols, aromatic polyhydric alcohols, and other polyhydric alcohols

The aliphatic polyhydric alcohol is an aliphatic alcohol having a valence of two or an aliphatic alcohol having a valence of three or more Examples of the aliphatic alcohol having valence of two include divalent aliphatic alcohols having at least 2 and no greater than 8 carbon atoms (specific examples include ethylene glycol, diethylene glycol, triethylene glycol, propanediol, 1,3-propanediol, 2,3-butanediol, 1,4-butanediol, 1,5-pentanediol, 1,6-hexanediol, neopentyl glycol, dimethylolheptane, dipropylene glycol, and 2,2,4-Trimethyl-1,3 pentanediol), polyethylene glycol, polypropylene glycol, and polytetramethylene glycol. Examples of the aliphatic alcohol having a valence of three or more include sorbitol, 1,2,3,6-hexatetraol, pentaerythritol, dipentaerythritol, tripentaerythritol, 1,2,4-butanetriol, 1,2,5-pentanetriol, 2-methyl-1,2,3-propanetriol, 2-methyl-1,2,4-butanetriol, trimethylolethane, trimethylolpropane, and glycerin.

Examples of the alicyclic polyhydric alcohol include alicyclic polyhydric alcohols having at least 6 and no greater than 12 carbon atoms (specific examples include 1,4-sorbitan, 1.4-cyclohexanediol, 1,4-cyclohexanedimethanol, 1,3-cyclohexanedimethanol, 1,2-cyclohexanedimethanol, and isosorbide), spiroglycol, tricyclodecanediol, tricyclodecanedimethanol, hydrogenated bisphenol A, a hydrogenated bisphenol A ethylene oxide adduct, and a hydrogenated bisphenol A propylene oxide adduct.

Examples of the aromatic polyhydric alcohol include bisphenol A, alkylene oxide adducts of bisphenol A, p-xylylene glycol, paraxylene glycol, metaxylene glycol, orthoxylene glycol, 1,4-phenylene glycol, 1,3,5-trihydroxymethylbenzene, ethylene oxide adducts of 1,4-phenylene glycol bisphenoxyethanol fluorene, and bis (4-(2-hydroxyethoxy) phenyl) fluorene.

Examples of other polyhydric alcohols include lactone-based polyester polyols obtained by ring-opening polymerization of lactones such as ε-caprolactone.

In order to obtain a non-crystalline polyester resin, the third monomer preferably contains at least a bisphenol A alkylene oxide adduct. The bisphenol A alkylene oxide adduct is a relatively large molecule, which causes steric hindrance during crystallization. Therefore, by using the bisphenol A alkylene oxide adduct, a crystalline region is less likely to be formed, and a non-crystalline polyester resin having a non-crystalline region is likely to be obtained. The number of moles of alkylene oxide added to bisphenol A is preferably 2 or more and 6 or less, and more preferably 2. The bisphenol A alkylene oxide adduct is preferably an alkylene oxide adduct of bisphenol A having at least 2 and no greater than 4 carbon atoms, more preferably a bisphenol A ethylene oxide adduct or a bisphenol A propylene oxide adduct, still more preferably a bisphenol A propylene oxide adduct, and particularly preferably a bisphenol A propylene oxide 2 mol adduct. A preferable example of the repeating unit derived from bisphenol A alkyleneoxide adduct, which is the third repeating unit, is represented by the following general formula (3A).

[chemical structure]

In General Formula (3A), each R represents a linear or branched alkylene group, m represents an integer of 0 or more, n represents an integer of 0 or more, and the sum of m and n is 2 or more and 6 or less. Each R preferably represents a linear or branched alkylene group having at least 2 and no greater than 4 carbon atoms, more preferably represents an ethylene group or a propylene group, and still more preferably represents a propylene group. The sum of m and n is preferably 2.

Specific examples of bisphenol A alkylene oxide adducts include polyoxypropylene-(2.3)-2,2-bis (4-hydroxyphenyl) propane, polyoxyethylene-(2.0)-2,2-bis (4-hydroxyphenyl) propane, polyoxypropylene (2.0)-2,2-bis (4-hydroxyphenyl) propane, polyoxypropylene-(2.2)-polyoxyethylene-(2.0)-2,2-bis (4-hydroxyphenyl) propane, polyoxypropylene (6)-2,2-bis (4-hydroxyphenyl) propane, polyoxypropylene-(2.2)-2,2-bis (4-hydroxyphenyl) propane, polyoxypropylene-(2.4)-2,2-bis (4-hydroxyphenyl) propane, and polyoxypropylene-(3.3)-2,2-bis (4-hydroxyphenyl) propane.

The third monomer preferably further contains an aliphatic polyhydric alcohol in addition to the bisphenol A alkylene oxide adduct. When the third monomer contains both the bisphenol A alkylene oxide adduct and the aliphatic polyhydric alcohol, the glass transition point of the polyester resin can be increased while imparting noncrystallinity to the polyester resin. As the aliphatic polyhydric alcohol, a divalent aliphatic alcohol is preferable, at least one compound of pentaerythritol, trimethylolpropane, glycerin, ethylene glycol, and diethylene glycol is preferable, at least one compound of ethylene glycol and diethylene glycol are more preferable, and ethylene glycol is particularly preferable. The repeating unit derived from ethylene glycol is represented by the following chemical formula (3B).

[chemical structure]

In order to increase the glass transition temperature of the polyester resin while imparting non-crystallinity to the polyester resin, the third monomers are two types, and are preferably ethylene glycol and a bisphenol A propylene oxide adduct.

In order to obtain a non-crystalline polyester resin having a high content of non-crystalline regions, the first monomer, second monomer and third monomer are preferably selected so as not to form regularity for forming crystalline regions. For the same reason, the polyester resin preferably has at least two types (e.g., two types) of second repeating units. For the same reason, the polyester resin preferably has at least two types (e.g., two types) of third repeating units. The higher the content of the non-crystalline region in the non-crystalline polyester resin, the more easily the non-crystalline polyester resin is dyed with a dye, and the more easily composite particles are produced

The content of a repeating unit containing an aromatic hydrocarbon in the total amount of the first repeating unit, the second repeating unit, and the third repeating unit is preferably 50 mol % or more, more preferably 50 mol % or more and 90 mol % or less, further preferably 50 mol % or more and 80 mol % or less, still more preferably 50 mol % or more and 70 mol % or less, and particularly preferably 55 mol % or more and 65 mol % or less. Hereinafter. “the content of the repeating unit containing the aromatic hydrocarbon in the total amount of the first repeating unit, the second repeating unit, and the third repeating unit” may be referred to as “aromatic unit ratio”. The dye contained in the composite particles often has an aromatic hydrocarbon. When the aromatic unit ratio is 50 mol % or more, the aromatic hydrocarbon contained in the dye and the aromatic hydrocarbon contained in the polyester resin are stacked to increase the interaction, and the dye and the polyester resin are easily complexed.

The glass transition point (Tg) of the polyester resin is preferably 40° C. or higher and 75° C. or lower, more preferably 45° C. or higher and 75° C. or lower, and still more preferably 45° C. or higher and 65° C. or lower. When the glass transition point of the polyester resin is 40° C. or higher, the polyester resin is less likely to be softened in a room temperature environment, and an ink having excellent storage stability is obtained. On the other hand, when the glass transition point of the polyester resin is 75° C. or lower, the composite particles containing the polyester resin adhere favorably to the recording medium even when the ink containing the composite particles is not heated or is heated at a low temperature after landing on the recording medium. When the glass transition point of the polyester resin is 40° C. or higher and 75° C. or lower, the composite particles are preferably plastically deformed on the recording medium when the ink containing the composite particles is landed on the recording medium and heated. Since the plastically deformed composite particles spread on the surface of the recording medium, an image having a high image density can be printed even when a small amount of ink is used.

The softening point (Tm) of the polyester resin is preferably 80° C. or higher and 200° C. or lower. When the softening point is 80° C. or higher, an ink having good fixability and storage stability can be obtained. For achieving satisfactory adherence of the composite particles containing a polyester resin to the recording medium, the softening point of the polyester resin is preferably 130° C. or higher and 200° C. or lower.

In order to favorably form composite particles by emulsification (for example, phase inversion emulsification) in an aqueous medium, the polyester resins preferably have an acid value of 10 mgKOH/g or more and 100 mgKOH/g or less.

The number average molecular weight of the polyester resin is preferably 2500 or more and 30000 or less, more preferably 4000 or more and 30000 or less, and still more preferably 10000 or more and 30000 or less. When the number average molecular weight of the polyester resin is 2500 or more, the strength of an ink film constituting a printed image is improved. When the number average molecular weight of the polyester resin is 30000 or less, the viscosity of the liquid containing the polyester resin does not become excessively high during the preparation of the composite particles, and thus the polyester resin and the dye can be uniformly complexed.

The polyester resin is preferably a linear polymer because of being easily complexed with a dye. However, the polyester resin may be crosslinked by a crosslinking agent having a functional group contributing to dispersion stability in the ink.

### (Polyester Resin Ratio)

The content of the polyester resin in the composite particles is 50% by mass or more and less than 100% by mass. Hereinafter, the “content of the polyester resin in the composite particles” may be referred to as a “polyester resin ratio”. When the polyester resin ratio is less than 50% by mass, the amount of the polyester resin is small, and thus, when the ink containing the composite particles is landed on the recording medium, the recording medium and the composite particles are difficult to adhere to each other, and the friction fastness of the formed image is reduced. In order to improve the friction fastness of the formed image, the polyester resin ratio is preferably 60% by mass or more, and more preferably 70% by mass or more. In order to form an image having a high image density, the polyester resin ratio is preferably 95% by mass or less, and more preferably 90% by mass or less. The polyester resin ratio can be changed, for example, by changing the addition amount of the polyester resin and the addition amount of the dye when the composite particles are prepared.

### (Dye Constituting Composite Particle)

The dye constituting the composite particles is not particularly limited. Examples of the dye include a disperse dye and an oil-soluble dye.

Disperse dyes or oil-soluble dyes have low hydrophilicity. However, by forming a composite with a polyester resin having a sulfur atom-containing polar group which is a hydrophilic group, composite particles containing a disperse dye or an oil-soluble dye can be satisfactorily emulsified and dispersed in an aqueous medium.

The disperse dye and the oil-soluble dye often have at least one of a nitro group and a quinone structure. The nitro group and the quinone structure have high affinity for the ester bond of the polyester resin. Therefore, when the non-crystalline region of the polyester resin is softened with an increase in temperature and the entanglement of the resin chains is weakened, the disperse dye and the oil-soluble dye easily penetrate into the non-crystalline region along the resin chains. Therefore, the disperse dye and the oil-soluble dye can be complexed with the polyester resin by a simple method (for example, a method of mixing the disperse dye or the oil-soluble dye with the polyester resin without using a solvent and a dispersant).

In addition, it is usually difficult to print on cotton fabric using disperse dyes or oil-soluble dyes. However, since the cotton fabric and the composite particles adhere to each other via the polyester resin in the composite particles, printing can be performed on the cotton fabric even when a disperse dye or an oil-soluble dye is used. Therefore, even when a disperse dye or an oil-soluble dye is used, printing can be performed regardless of the type of recording medium (for example, cotton cloth or polyester cloth).

Disperse dyes include, for example, C. I. Disperse Yellow 51, 54, and 60; C. I. Disperse Orange 5, 7, 20, and 23; C. I. Disperse Red 50, 53, 59, 60, 239, and 240; C. I. Disperse Violet 8, 11, 17, 26, 27, 28, and 36; C. I. Disperse Blue 3, 5, 26, 35, 55, 56, 72, 81, 91, 108, and 359; C. I. Disperse Yellows 42, 49, 76, 83, 88, 93, 99, 119, 126, 160, 163, 165, 180, 183, 186, 198, 199, 200, 224, and 237; C. I. Disperse Oranges 29, 30, 31, 38, 42, 44, 45, 53, 54, 55, 71, 73, 80, 86, 96, 118, and 119; C. I. Disperse Red 73, 88, 91, 92, 111, 127, 131, 143, 145, 146, 152, 153, 154, 179, 191, 192, 206, 221, 258, 283, 302, 323, 328, and 359; C. I. Disperse Violet 26 35 48 56 77, and 97; and C. I. Disperse Blue 27, 54, 60, 73, 77, 79, 79:1, 87, 143, 165, 165:1, 165:2, 181, 1 85, 197, 225, 257, 266, 267, 281, 341, 353, 354, 358, 364, 365, 368, 359, and 360

Oil-soluble dyes include, for example, C. I. Solvent Yellow 114; C. I. Solvent Orange 67; C. I. Solvent Red 146; and C. I. Solvent Blue 36, 63, 83, 105, and 111.

In addition, a dye which is adjusted to black by mixing dyes of a plurality of colors may be used. For example, a mixed dye in which an orange dye and a red dye are mixed with a blue dye as a main component may be used as the black dye. The color tone may be finely adjusted by further blending a dye other than the orange dye and the red dye into the black dye

As the dye, a disperse dye and an oil-soluble dye having thermal transfer suitability are preferable because they are suitable for a heating step during image formation. The preferred disperse dyes having thermal transfer suitability are C. I. Disperse Yellow 51, 54, and 60; C. I. Disperse Orange 5, 7, 20, and 23; C. I. Disperse Red 50, 53, 59, 60, 239, and 240; C. I. Disperse Violet 8, 11, 17, 26, 27, 28, and 36; and C. I. Disperse Blue 3, 5, 26, 35, 55, 56, 72, 81, 91, 108, and 359. The preferred oil-soluble dye having thermal transfer suitability are, C. I. Solvent Yellow 114: C. I. Solvent Orange 67; C. I. Solvent Red 146; and C. I. Solvent Blue 36, 63, 83, 105, and 111.

The composite particles may contain only one type of dye or 2 or more types of dyes. The content of the dye relative to the mass of the ink is preferably 0.5% by mass or more and 10.0% by mass or less, more preferably 1.0% by mass or more and 7.0% by mass or less, and still more preferably 1.0% by mass or more and 3.0% by mass or less. When the content of the dye is 0.5% by mass or more relative to the mass of the ink, a sufficient image density can be ensured on a formed image. When the content of the dye is 10.0% by mass or less relative to the mass of the ink, sufficient saturation can be secured on the formed image

### <Aqueous Medium>

The aqueous medium is a medium containing water as a main component. The aqueous medium may function as a solvent or a dispersion medium. Specific examples of the aqueous medium include water and a mixture of water and a hydrophilic organic solvent. Examples of the hydrophilic organic solvent contained in the aqueous medium include ketone solvents (specific examples include acetone), alcohol solvents (specific examples include methanol, ethanol, and isopropyl alcohol); and glycol ether solvents (specific examples include ethylene glycol monomethyl ether, ethylene glycol monobutyl ether, and ethylene glycol monotertiary butyl ether). The content of water in the aqueous medium is preferably 70% by mass or more, more preferably 80% by mass or more, and still more preferably 90% by mass or more. The ink may contain only one type of aqueous media or two or more types of aqueous media. The aqueous medium is preferably water or a mixed solvent of water and ethylene glycol monobutyl ether.

The content of the aqueous medium is preferably 5% by mass or more and 99% by mass or less and more preferably 50% by mass or more and 90% by mass or less relative to the mass of the ink. When the content of the aqueous medium is within such a range, it is possible to obtain an ink having an appropriate viscosity.

### <Surfactant>

The ink may contain a surfactant as necessary. When the ink contains a surfactant, an ink having excellent wettability with respect to the recording medium can be obtained. Examples of the surfactant include an anionic surfactant, a cationic surfactant, a nonionic surfactant, and an amphoteric surfactant. The ink may contain only one type of surfactant, and may contain two or more types of surfactants (e.g., two types or three types of surfactants).

The surfactant is preferably a nonionic surfactant, more preferably a surfactant having an acetylene glycol structure, and still more preferably an acetylene diol ethylene oxide adduct. The HLB value of the surfactant is preferably 1 or more and 5 or less. The HLB value of the surfactant is calculated, for example, by the Griffin method from the formula “HLB value=20×(sum of formula weight of hydrophilic part)/molecular weight”.

The content of the surfactant is preferably 0.01% by mass or more and 0.50% by mass or less relative to the mass of the ink. When the content of the surfactant is within such a range, an ink having excellent dispersion stability of the composite particles can be obtained. In addition, when the content of the surfactant is 0.50% by mass or less, bubbles are less likely to be generated from the ink in the nozzles of the recording head included in the inkjet recording apparatus, and the ink can be stably discharged from the nozzles.

### <Humectant>.

The ink may contain a humectant as necessary. When the ink contains a humectant, volatilization of the liquid component from the ink can be suppressed. Humectants include, for example, sorbitol, polyalkylene glycols, alkylene glycols, and glycerin. Examples of polyalkylene glycols include polyethylene glycol and polypropylene glycol. Examples of alkylene glycols include, 3-methyl-1,5-pentanediol, ethylene glycol, propylene glycol, butylene glycol, diethylene glycol, dipropylene glycol, trimethylene glycol (i.e., 1,3-propanediol), triethylene glycol, tripropylene glycol, 1,2,6-hexanetriol, thiodiglycol, 1,3-butanediol, and 1,5-pentanediol. The humectant is preferably at least one of alkylene glycols and glycerin, and more preferably at least one of propylene glycol and glycerin. The content of the humectant relative to the mass of the ink is preferably 0.1% by mass or more and 10.0% by mass or less, and more preferably 0.1% by mass or more and 5.0% by mass or less.

### <Additives>

The ink preferably further contains a blocked isocyanate compound as necessary. The blocked isocyanate compound functions as, for example, a crosslinking agent. The crosslinking reaction by the blocked isocyanate compound and the advantages obtained by the ink containing the blocked isocyanate compound will be described later in the second embodiment. The blocked isocyanate compound is preferably a polyurethane containing a blocked isocyanate structure. The blocked isocyanate compound is dispersed in the ink in the form of, for example, latex particles. The content of the blocked isocyanate compound is preferably 0.1% by mass or more and 5.0% by mass or less relative to the mass of the ink.

The ink, as necessary, may further contain additives other than the blocked isocyanate compound (more specifically, a viscosity modifier, a dissolution stabilizer, a penetrant, an antioxidant, an ultraviolet absorber, and the like).

The ink preferably contains no pigment. By not containing a pigment having a relatively large particle diameter, it is possible to suppress the stiffness of the recording medium on which an image is printed and to improve the friction fastness. In addition, it is possible to suppress a decrease in image density and a decrease in saturation, which are caused by the particulate pigment entering the inside of the recording medium (for example, between the fibers of the cloth).

### <Method for Producing Ink>

Next, an example of a method for producing the ink of the first embodiment will be described. The method for producing the ink of the first embodiment includes, for example, a polyester resin preparation step, a composite particle preparation step, and a mixing step.

### (Polyester Resin Preparation Step)

In the polyester resin preparation step, a polyester resin having a sulfur atom-containing polar group is prepared. Specifically, in the polyester resin preparation step, the polyester resin is obtained by condensation polymerization of the first monomer, second monomer, and third monomer

In the polyester resin-preparing step, the first monomer is added in an amount (amount of substance) of 1 mol % or more and 10 mol % or less relative to the total amount (total amount of substance) of the first monomer and the second monomer. Hereinafter, the “percentage of the amount of the first monomer relative to the total amount of the first monomer and the second monomer” may be referred to as a “first monomer ratio”. When the first monomer ratio is within such a range, the first repeating unit ratio can be adjusted to 1 mol % or more and 10 mol % or less. In order to obtain an ink which is excellent in dispersibility and discharge stability and is excellent in friction fastness of a formed image, the first monomer ratio is preferably 3 mol % or more and 10 mol % or less, and more preferably 5 mol % or more and 10 mol % or less.

The condensation polymerization can be carried out by a known method. Examples of the condensation polymerization method include a vacuum polymerization method, a reduced-pressure polymerization method, and an acid chloride method. In the reduced-pressure polymerization method, a polyester resin having a low molecular weight is easily obtained as compared with the vacuum polymerization method.

An example of the condensation polymerization method will be described below. The first monomer, the second monomer, and the third monomer are stirred in the presence of a catalyst while reducing the pressure to a predetermined pressure. In this manner, the first monomer, the second monomer, and the third monomer are subjected to condensation polymerization. Catalysts include, for example, zinc acetate and antimony trioxide. The predetermined pressure is preferably 1 mmHg or more and 10 mmHg or less. The condensation polymerization time is, for example, preferably 0.5 hours or more and 10 hours or more; and more preferably 1 hours or more and 5 hours or less.

The condensation polymerization temperature is preferably 130° C. or more and 250° C. or less. In the case where the addition amount ratio of each monomer is an addition amount ratio in which reactivity is dominant, it is preferable to lower the condensation polymerization temperature. For example, in the case where the third monomer contains an alkylene oxide adduct of bisphenol A, it is preferable to lower the condensation polymerization temperature as the addition amount of the alkylene oxide adduct of bisphenol A is decreased. In addition, in a case where the first monomer and the second monomer contain a trivalent carboxylic acid, it is preferable to lower the condensation polymerization temperature as the addition amount of the trivalent carboxylic acid is increased. It is preferable to lower the condensation polymerization temperature as the total number of hydroxy groups relative to the total number of carboxy groups is small.

### (Composite Particle Preparation Step)

In the composite particle preparation step, composite particles that are particles of a composite of a polyester resin and a dye are prepared.

In the composite particle preparation step, first, the polyester resin and the dye are mixed to obtain a mixture. At the time of mixing, the polyester resin is added in an amount of 50% by mass or more and less than 100% by mass relative to the total mass of the materials (for example, the polyester resin and the dye) for forming the composite particles. By adding the polyester resin in such an amount, the polyester resin ratio of the composite particles can be adjusted to 50% by mass or more and less than 100% by mass. In order to uniformly disperse the dye in the polyester resin, the obtained mixture of the polyester resin and the dye may be kneaded and pulverized as necessary. The pulverized product obtained by the pulverization is, for example, in the form of chips.

Next, the obtained mixture of the polyester resin and the dye is stirred in an aqueous medium to be emulsified and dispersed. As a result, composite particles are obtained. It is preferable that components other than the mixture of the polyester resin and the dye are not added to the aqueous medium used in the composite particle preparing step. For example, it is preferable that a neutralizer and a dispersant (more specifically, an emulsifier, a surfactant, and the like) are not added to the aqueous medium used in the composite particle preparation step. Since appropriate hydrophilicity is imparted to the composite particles by the polyester resin having a sulfur atom-containing polar group, the composite particles are satisfactorily emulsified and dispersed in an aqueous medium even when a neutralizing agent and a dispersant are not added.

The temperature of the aqueous medium during stirring is preferably a temperature equal to or higher than the glass transition point of the polyester resin. At such a temperature, the non-crystalline region of the polyester resin is softened, the entanglement of the resin chains is weakened, and the dye easily permeates into the non-crystalline region along the resin chains

Whether or not the dye is introduced into the polyester resin can be confirmed by the following method. After the composite particles are formed, the aqueous medium containing the composite particles is collected. The aqueous medium containing the composite particles is centrifuged using a centrifugal separator at a rotation speed of 15000 rpm for 30 minutes. After centrifugation, the supernatant is recovered. The dye contained in the supernatant is quantified by an absorbance method using a spectrophotometer (for example, manufactured by Hitachi, Ltd.). The amount of dye contained in the supernatant corresponds to the amount of dye not introduced into the polyester resin.

### (Mixing Step)

In the mixing step, the aqueous medium and the composite particles are mixed. For example, a stirrer is used for mixing. An ink component (more specifically, at least one of a surfactant, a humectant, and an additive) to be added as necessary may be further added and mixed. The resulting mixture is optionally filtered. As a result, the ink of the first embodiment is produced. The method manufacturing the ink of the first embodiment has been described above.

### Second Embodiment: Image Forming Method

A second embodiment of the present disclosure relates to an image forming method. The image forming method of the second embodiment includes, for example, a discharging step. In the discharging step, an ink is discharged from a discharge surface of a recording head to a recording medium. The discharged ink is the ink of the first embodiment.

In order to improve the friction fastness of a formed image, the image forming method of the second embodiment preferably further includes a heating step in addition to the discharging step. In the heating step, the ink landed on the recording medium is heated.

The ink of the first embodiment is used in the image forming method of the second embodiment. Since the ink of the first embodiment is excellent in dispersibility and discharge stability, according to the image forming method of the second embodiment using such an ink, an image with few image defects can be printed. In addition, since the ink of the first embodiment can print an image having excellent friction fastness, according to the image forming method of the second embodiment using such an ink, an image having excellent friction fastness can be printed.

In addition, as compared with the sublimation printing method, the image forming method of the second embodiment has an advantage that the molecular weight of the dye to be used is not limited because sublimation transfer in a short time is not required, an advantage that the formed image has excellent friction fastness; and an advantage that there will be no dye remaining on the transfer paper because no transfer paper is used. The sublimation printing method is a method in which an ink is discharged onto a transfer paper using an inkjet recording apparatus, and then a sublimation dye in the ink is sublimated and transferred from the transfer paper to a recording medium by heating.

In addition, the image forming method of the second embodiment has an advantage in that bleeding of the dye spreading along the fibers of the recording medium due to a capillary phenomenon is less likely to occur and an image having clear edges can be formed, and an advantage in that a post-treatment for washing away the unfixed dye is unnecessary, as compared with the case of using an ink containing a dye which is not complexed.

Hereinafter, an example of the image forming method according to the second embodiment will be specifically described with reference to FIG. 1. FIG. 1 shows a configuration of an inkjet recording apparatus 1 used in the image forming method according to the second embodiment. FIG. 2 is a diagram illustrating the discharging step of the image forming method according to the second embodiment. FIG. 2 is a side view of the recording head 4 of the inkjet recording apparatus 1 shown in FIG. 1. Here, the X-axis, the Y-axis, and the Z-axis shown in FIGS. 1 and 2 are orthogonal to one another.

The inkjet recording apparatus 1 shown in FIG. 1 includes a sheet feeding unit 3, a recording head 4, a liquid containing unit 5, a heating unit 6, a sheet conveying unit 7, and a discharge unit 8.

The sheet feeding unit 3 includes a plurality of sheet feeding cassettes 31 and a plurality of sheet feeding rollers 32a. A plurality of recording media S (for example, cloth or copy paper) are stored in the paper feed cassette 31 in a stacked manner.

As shown in FIG. 2, the recording head 4 is provided with nozzles 41, an ink inflow port 43, and an ink outflow port 45. The recording head 4 has an discharge surface 47. The nozzles 41 are open on the discharge surface 47 and discharge ink toward the recording medium S (see FIG. 1). The recording head 4 is, for example, a line head. The ink is stored in an ink tank 51 (see FIG. 1). The ink flows into the recording head 4 from the ink tank 51 through the ink inlet 43, and flows out of the recording head 4 through the ink outlet 45.

As shown in FIG. 1, the liquid containing portion 5 includes the ink tank 51. The ink tank 51 contains the ink of the first embodiment

The heating unit 6 includes a heating device 60. The heating device 60 is provided at a position opposed to a second conveyance surface 72a of a second conveyance unit 72.

The sheet conveyance unit 7 includes a first conveyance unit 71 and the second conveyance unit 72. The discharge unit 8 has a discharge tray 81.

A method for forming an image on the recording medium S by using the inkjet recording apparatus 1 illustrated in FIG. 1 will be described. First, a sheet feeding roller 32a picks up the recording medium S stored in the sheet feeding cassette 31 one by one from the uppermost part. Then, the sheet feeding roller 32a sends out the picked-up recording medium S to the first conveyance unit 71.

Next, a discharge step is performed. In the discharge step, when the recording medium S reaches the position facing the discharge surface 47 (see FIG. 2), the ink is discharged from the discharge surface 47 (more specifically, the openings of the nozzles 41) onto the recording medium S on a first conveyance surface 71a of the first conveyance unit 71. The recording medium S on which the ink has landed is conveyed from the first conveyance unit 71 to the second conveyance unit 72.

Next, a heating step is performed. In the heating step, the heating device 60 heats the recording medium S on the second conveyance surface 72a of the second conveyance unit 72. In this way, the ink landed on the recording medium S is heated. By heating, the recording medium S and the composite particles are adhered to each other through the polyester resin in the composite particles. When the recording medium S is a polyester fiber cloth formed of a polyester resin having a non-crystalline region, a part of the dye in the composite particle moves to the non-crystalline region of the polyester resin of the polyester fiber cloth by heating, and the polyester fiber cloth and the dye are integrated with each other.

The heating device 60 is, for example, a drying device that blows hot air to the recording medium S. In order to improve the feel of the recording medium S, the temperature at which the heating device 60 heats the recording medium S (for example, the temperature of hot air) is preferably 200° (or lower, and more preferably 180° C. or lower. In order to improve the friction fastness of the formed image, the temperature of the heat treatment is preferably 100° C. or higher, and more preferably 130° C. or higher

In order to improve the friction fastness of the formed image, the ink preferably further contains a blocked isocyanate compound as a crosslinking agent, and the recording medium S preferably has a hydroxy group. The polyester resin contained in the composite particles in the ink has a hydroxy group. Therefore, in a case where such an ink and the recording medium S are used, when the ink landed on the recording medium S is heated by the heating device 60, the hydroxy group of the recording medium S and the hydroxy group of the polyester resin contained in the composite particles in the ink are crosslinked by the crosslinking agent (blocked isocyanate compound).

The crosslinking reaction by the blocked isocyanate compound will be described below. The blocked isocyanate compound has two blocked isocyanate groups. The blocked isocyanate group is an isocyanate group sealed with a blocking agent. When the ink is not heated, the isocyanate group is sealed with the blocking agent, and thus the blocked isocyanate compound does not react with the hydroxy group. However, when the ink is heated, the blocking agent is separated from the blocked isocyanate group to form an isocyanate group, which reacts with the hydroxy group. One of the two isocyanate groups formed by separating the blocking agent from the two blocked isocyanate groups of the blocked isocyanate compound reacts with the hydroxy group of the recording medium S. The other of the two isocyanate groups reacts with the hydroxy group of the polyester resin contained in the composite particles in the ink. Through these reactions, the hydroxy group of the recording medium S and the hydroxy group of the polyester resin contained in the composite particles in the ink are bonded to each other via a crosslinking structure derived from the crosslinking agent (derived from the blocked isocyanate compound). As a result of the bonding between the recording medium S and the composite particles via the crosslinked structure, the dye contained in the composite particles is less likely to be separated from the recording medium S, and the friction fastness of the formed image is improved. The crosslinking reaction by the blocked isocyanate compound has been described above.

After the heating step is performed, the recording medium S is discharged from the second conveyance unit 72 to the discharge tray 81.

The example of the image forming method according to the second embodiment has been described above with reference to FIGS. 1 and 2. However, the image forming method according to the second embodiment is not limited to the above-described method, and for example, the following points can be changed.

Although the image forming method using the inkjet recording apparatus 1 including the ink tank 51 has been described, a cartridge including the ink tank may be attached to the inkjet recording apparatus to form an image. The cartridge is attachable to and detachable from the inkjet recording apparatus.

Although the drying device that blows hot air to the recording medium S has been described as the heating device 60, the heating device may be, for example, a pressure heating device or a steam heating device. Although the image forming method using the inkjet recording apparatus 1 including the heating device 60 has been described, the heating device does not have to be provided in the inkjet recording apparatus. For example, after an image is formed on a recording medium using an inkjet recording apparatus, the recording medium on which the image is formed may be heated using a heating apparatus independent of the inkjet recording apparatus (that is, separate from the inkjet recording apparatus). The heating step may be omitted when an image having desired friction fastness can be formed.

A pretreatment may be performed on the recording medium S before an image is formed on the recording medium S. By performing the pretreatment, blurring of the image to be printed is suppressed, and an image having high color developability and high sharpness can be printed.

In order to improve friction fastness of the formed image, the recording medium S on which the image is formed may be further subjected to a metal ion treatment, an acid treatment, or an alkali treatment.

### EXAMPLES

Next, an embodiment of the present disclosure will be described. In the evaluation in which an errors occur, a substantial number of measurement values having sufficiently small errors were obtained, and the arithmetic average of the obtained measurement values was taken as an evaluation value.

### [Preparation of Polyester Resin]

First, polyester resins (A1) to (A4) and (B1) to (B2) (hereinafter referred to as resins (A1) to (A4) and (B1) to (B2), respectively) were prepared. The compositions of the resins (A1) to (A4) and (B1) to (B2) are shown in Table 1 below.

TABLE 1

| Resin | | A1 | A2 | A3 | A4 | B1 | B2 |
|---|---|---|---|---|---|---|---|
| Second | DMT [g] | 50 | 50 | 50 | — | 50 | 50 |
| monomer | IPA [g] | 45 | 40 | 35 | 35 | 50 | 25 |
| | NDCN [g] | — | — | — | 50 | — | — |
| First | SSIPA [g] | 5 | 10 | 15 | 15 | — | 25 |
| monomer | | | | | | | |
| Third | BPO-PO [g] | 70 | 70 | 70 | 70 | 70 | 70 |
| monomer | EG [g] | 30 | 30 | 30 | 30 | 30 | 30 |

| | | | | | | |
|---|---|---|---|---|---|---|
| First repeating unit ratio | 3 | 6 | 9 | 8 | 0 | 15 |
| [mol %] | | | | | | |
| Aromatic unit ratio | 61 | 60 | 60 | 58 | 61 | 59 |
| Tg [° C.] | 50 | 52 | 54 | 64 | 47 | 59 |

The meaning of each term in Table 1 will be described. “Tg” represents a glass transition point (unit: ° C.). “DMT” refers to dimethyl terephthalate. “IPA” refers to isophthalic acid. “NDCN” refers to dimethyl 2,6-naphthalenedicarboxylate. “SSIPA” refers to sodium 5-sulfoisophthalate. “BPO-PO” refers to bisphenol A propylene oxide 2 mol adduct. “EG” refers to ethylene glycol. “-” indicates that the corresponding monomer was not used.

The “first repeating unit ratio” indicates the content ratio (unit: mol %) of a first repeating unit in the total amount of the first repeating unit and a second repeating unit. The first repeating unit ratio is calculated from the formula “first repeating unit ratio=100×(amount of substance of first repeating unit)/[(amount of substance of first repeating unit)+(amount of substance of second repeating unit)]=100×(amount of substance of repeating unit derived from sodium 5-sulfoisophthalate)/[(amount of substance of repeating unit derived from sodium 5-sulfoisophthalate)+(amount of substance of repeating unit derived from dimethyl terephthalate)+(amount of substance of repeating unit derived from isophthalic acid)+(amount of substance of repeating unit derived from dimethyl 2,6-naphthalenedicarboxylate)]”.

The “aromatic unit ratio” indicates the content (unit: mol %) of the repeating unit containing an aromatic hydrocarbon in the total amount of the first repeating unit, the second repeating unit, and the third repeating unit. The aromatic unit ratio is represented by the formula “aromatic unit ratio=100/(amount of substance of repeating unit containing aromatic hydrocarbon)/[(amount of substance of first repeating unit)+(amount of substance of second repeating unit)+(amount of substance of third repeating unit)]=100×[(amount of substance of repeating unit derived from sodium 5-sulfoisophthalate)+(amount of substance of repeating unit derived from dimethyl terephthalate)+(amount of substance of repeating unit derived from isophthalic acid)+(amount of substance of repeating unit derived from dimethyl 2,6-naphthalenedicarboxylate)+(amount of substance of repeating unit derived from bisphenol A propylene oxide 2 mol adduct)]/[(amount of substance of repeating unit derived from sodium 5-sulfoisophthalate)+(amount of substance of repeating unit derived from dimethyl terephthalate)+(amount of substance of repeating unit derived from isophthalic acid)+(amount of substance of repeating unit derived from dimethyl 2,6-naphthalenedicarboxylate)+(amount of substance of repeating unit derived from bisphenol A propylene oxide 2 mol adduct)+(amount of substance of repeating unit derived from ethylene glycol)].

The amount of substance of the monomer before the condensation polymerization reaction is the same as the amount of substance of the corresponding repeating unit after the condensation polymerization reaction. Thus, the amount of substance of each repeating unit is calculated from the formula “[amount of substance of repeating unit (unit: mol)]=[amount of substance of corresponding monomer added (unit: mol)]=[mass of corresponding monomer added (unit: g)]/[molar mass of monomer (unit: g/mol)]”. The molar mass of the monomer corresponds to the molecular weight of the monomer. For example, in the preparation of resins, if 45 g of the isophtalic acid as the monomer (molar mass: 166 g/mol) is added, the amount of substance of repeat unit derived from isophtalic acid is calculated from the formula “amount of substance of repeat unit derived from isophtalic acid=amount of substance of isophtalic acid added=mass of isophtalic acid added (45 g)/molar mass of isophtalic acid added (166 g/mol)” as 0.27 mol. The meaning of each term in Table 1 has been described above.

<Preparation of resins (A1)>

A four necked flask equipped with a fractionating column, a nitrogen inlet tube, a thermometer, and a stirrer was prepared. The flask was charged with dimethyl terephthalate (50 g), sodium 5-sulfoisophthalate (5 g), bisphenol A propylene oxide 2 mole adduct (70 g), ethylene glycol (30 g), and zinc acetate (0.1 g) as a catalyst. The temperature of the flask contents was raised from 130° C. to 170° C. over 2 hours. Isophtalic acid (45 g) and antimony trioxide (0.1 g) were added into the flask. The temperature of the flask contents was raised from 170° C. to 200° C. over 2 hours. Next, the pressure in the flask was gradually reduced from atmospheric pressure to 5 mmHg while gradually raising the temperature of the flask contents from 200° C. to 250° C. The flask contents were subjected to a polycondensation reaction for 1 hour under the conditions of a flask internal temperature of 250° C. and a flask internal pressure of 5 mmHg to obtain a resin (A1).

### <Preparation of Resins (A2) to (A4) and (B1) to (B2)>

Resins (A2) to (A4) and (B1) to (B2) were prepared in the same manner as in the preparation of the resins (A) except that the monomers were used in the types and amounts shown in Table 1.

### <Measurement of Glass Transition Point and Melting Point>

The glass transition points (Tg) and melting points (Mp) of the resins (A1) to (A4) and (B1) to (B2) were measured using a differential scanning calorimeter (“DSC-60” manufactured by Shimadzu Corporation) according to JIS (Japanese Industrial Standard) K7121-2012.

The glass transition points of the resins (A1) to (A4) and (B1) to (B2) are shown in Table 1 above. In each of the resins (A1) to (A4) and (B1) to (B2), a glass-transition point was confirmed in the heat absorption curve, but no clear melting point was confirmed, and the resins were determined to be non-crystalline polyester resins.

### [Preparation of Emulsified Dispersion]

Next, emulsified dispersions (DA-1) to (DA-8) and (DB-1) to (DB-4) were prepared. The compositions of these emulsified dispersions are shown in Table 2. The emulsified dispersions (DA-1) to (DA-8) and (DB-1) to (DB-4) contain composite particles (CA-1) to (CA-8) and (CB-1) to (CB-4), respectively. The compositions of these composite particles are shown in the “Composition” column of Table 2.

TABLE 2

| Emulsified dispersion | | | DA-1 | DA-2 | DA-3 | DA-4 | DA-5 | DA-6 |
|---|---|---|---|---|---|---|---|---|
| Composite particles | | | CA-1 | CA-2 | CA-3 | CA-4 | CA-5 | CA-6 |
| Compo- | Resin | Type | A1 | A2 | A3 | A4 | A1 | A3 |
| sition | | Amount [part] | 160 | 160 | 160 | 160 | 120 | 120 |
| | | Content [% by | 80 | 80 | 80 | 80 | 60 | 60 |
| | | mass] | | | | | | |
| | Dye | Type | D.B. 359 | D.B. 359 | D.B. 359 | D.B. 359 | D.B. 359 | D.B. 359 |
| | | Amount [part] | 40 | 40 | 40 | 40 | 80 | 80 |
| EG-MBE | | Amount [part] | 100 | 70 | 50 | 50 | 100 | 50 |
| Water | | Amount [part] | 700 | 730 | 750 | 750 | 700 | 750 |
| Emulsified dispersion | | | DA-7 | DA-8 | DB-1 | DB-2 | DB-3 | DB-4 |
| Composite particles | | | CA-7 | CA-8 | CB-1 | CB-2 | CB-3 | CB-4 |
| | | | | | (Formation | (Formation | | |
| | | | | | impossible) | impossible) | | |
| Compo- | Resin | Type | A1 | A1 | B1 | B2 | A1 | A3 |
| sition | | Amount [part] | 160 | 120 | 160 | 160 | 80 | 80 |
| | | Content [% by | 80 | 60 | 80 | 80 | 40 | 40 |
| | | mass] | | | | | | |
| | Dye | Type | D.R. 60 | D.Y. 54 | D.B. 359 | D.B. 359 | D.B. 359 | D.B. 359 |
| | | Amount [part] | 40 | 80 | 40 | 40 | 120 | 120 |

| | | | | | | | |
|---|---|---|---|---|---|---|---|
| EG-MBE | Amount [part] | 100 | 100 | 50 | 50 | 100 | 50 |
| Water | Amount [part] | 700 | 700 | 750 | 750 | 700 | 750 |

The meaning of each term in Table 2 will be described. “EG-MBE” refers to ethylene glycol monobutyl ether. “Water” refers to ion-exchanged water. In Table 2 and Table 3 described later. “part” indicates “part by mass”. “D. B. 359”, “D. R. 60”, and “D. Y. 54” are as shown below, and are all disperse dyes.

### D. B. 359: C. I. Disperse Blue 359

### D. R. 60: C. I. Disperse Red 60

### D. Y. 54: C. I. Disperse Yellow 54

The “content” means a polyester resin ratio (unit:% by mass). The polyester resin ratio is calculated from the formula “polyester resin ratio=100×(mass of polyester resin)/(mass of composite particles)=100/(mass of polyester resin)/[(mass of polyester resin)+(mass of dye)]”. The meaning of each term in Table 2 has been described above.

### <Preparation of Emulsified Dispersion (DA-1)>

Resins (A1) (160 parts by mass) and C. I. Disperse Blue 359 (40 parts by mass) were mixed using an FM mixer (manufactured by Nippon Coke & Engineering Co., Ltd.) to obtain a mixture. The mixture was kneaded using a 2 screw extruder (“PCM-30” manufactured by Ikegai Corporation) to obtain a kneaded product. The kneaded product was pulverized using a pulverizer (“Rotoplex (registered Japanese trademark)” manufactured by Hosokawa Micron Corporation) to obtain a chip-shaped colored kneaded product. Next, the colored kneaded product (200 parts by mass), ion-exchanged water (700 parts by mass), and ethylene glycol monobutyl ether (100 parts by mass) were charged into a four-necked flask equipped with a nitrogen inlet tube, a reflux condenser, a stirrer, and a thermocouple. The flask contents were mixed at 90° C. for 2 hours to emulsify and disperse the colored kneaded product. Then, the flask contents were cooled to room temperature with stirring to obtain an emulsified dispersion (DA-1).

The emulsified dispersion (DA-1) contained composite particles (CA-1) obtained by microparticulating the chip-shaped colored kneaded product by emulsification. The colored kneaded product formed from 160 parts by mass of the resin (A1) and 40 parts by mass of C. I. Disperse Blue 359 was microparticulated by emulsification to obtain the composite particles (CA-1). Thus, the content of the resin (A1) in the composite particles (CA-1) was calculated to be 80% by mass from the formula “100×160/(160+40)”.

### <Preparation of Emulsified Dispersions (DA-2) to (DA-8) and (DB-1) to (DB-4)>

Emulsified dispersions (DA-2)-(DA-8) and (DB-1)-(DB-4) were prepared in the same manner as emulsified dispersions (DA-1) except that the type and amount of resin shown in Table 2, the type and amount of dye shown in Table 2, the amount of ethylene glycol monobutyl ether shown in Table 2, and the amount of ion-exchanged water shown in Table 2 were used.

The emulsified dispersions (DA-2) to (DA-8) and (DB-3) to (DB-4) contained the composite particles (CA-2) to (CA-8) and (CB-3) to (CB-4), obtained by microparticulating the chip-shaped colored kneaded product by emulsification, respectively.

On the other hand, in the preparation of the emulsified dispersion (DB-1), the chip-shaped colored kneaded product was not emulsified and turned into a lumpy aggregate, and the fine composite particles (CB-1) could not be formed. In addition, in the preparation of the emulsified dispersion (DB-2), the chip-shaped colored kneaded product was completely dissolved, and the fine composite particles (CB-2) could not be formed.

### [Preparation of Inks]

### <Preparation of ink (IA-1)>

Next, an ink (IA-1) was prepared. The composition of the ink (IA-1) is shown in Table 3.

TABLE 3
Ink (IA-1)

| Component | Amount [part] |
|---|---|
| Emulsified dispersion (DA-1) | 100 |
| Propylene glycol | 20 |
| Glycerin | 20 |
| Surfynol | 0.5 |
| Crosslinking agent | 45 |
| Total | 145 |

Emulsified dispersion (DA-1) (100.0 parts by mass, content of composite particles: 20% by mass), propylene glycol (20.0 parts by mass), glycerin (20.0 parts by mass), a surfactant (“Surfynol (registered trademark) 104PG-50” manufactured by Nissin Chemical Industry Co., Ltd., a surfactant having an acetylene glycol structure, HLB value: 4, active ingredient concentration: 50% by mass) (0.5 parts by mass), and a crosslinking agent (polyurethane containing a blocked isocyanate structure, “Meikanate Cx” manufactured by Meisei Chemical Industry Co., Ltd.) (4.5 parts by mass) were stirred with a stirrer at 20° C. for 15 minutes to obtain ink (IA-1).

The final dye concentration of the ink (IA-1) was 2.7% by mass. The viscosity of the ink (IA-1) was 5.5 mPa·s. The viscosity of the ink (IA-1) was measured at 25° C. in accordance with the method described in “JIS (Japanese Industrial Standard) Z 8803:2011 Method for Measuring Viscosity of Liquid”.

### <Preparation of Inks (IA-2) to (IA 8) and (IB-1) to (IB-4)>

Inks (IA-2) to (IA-8) and (IB-1) to (IB-4) were prepared in the same manner as in the preparation of the ink (IA-1) except that the emulsified dispersions shown in Table 4 below were used.

### <Measurement of Volume Median Diameter of Composite Particles Contained in the Ink>

The volume median diameter of the composite particles contained in the ink was measured according to the method described in ISO 22412:2017 using a laser diffraction particle size distribution measuring device (“Zeta Sizer Nano ZS” manufactured by Malvern Co., Ltd.). The volume median diameter of the measured composite particles is shown in Table 4.

### [Evaluation Method]

Each of the inks (IA-1) to (IA-8) and (IB-3) to (IB-4) to be evaluated was used to perform the following evaluation. The inks (IB-1) and (IB-2) could not be evaluated for the reasons described later.

### <Evaluation of Dispersion State of Ink>

The ink was filtered using a membrane filter (average pore size: 5 μm). The amount of coarse particles (coarse composite particles) remaining on the filter without passing through the filter was visually confirmed, and the dispersion state of the ink was evaluated according to the following criteria. The evaluation results are shown in Table 4. An ink evaluated as A or B was determined to have a good dispersion state, and an ink evaluated as C was determined to have a poor dispersion state.

Evaluation A: No coarse particles remain on the filter.
Evaluation B: Some coarse particles remain on the filter, but filtration is not hindered by the influence thereof.
Evaluation C: Coarse particles remain on the filter, and filtration is hindered by the influence thereof.

### <Evaluation of Discharge Stability and Friction Fastness>

For the evaluation of the discharge stability and the friction fastness, an inkjet print test jig equipped with a recording head (inkjet print head “KJ4B” manufactured by KYOCERA CORPORATION) was used. The ink filtered using a membrane filter (average pore diameter: 5 μm) in the above-described <evaluation of dispersion state of ink> was filled in an ink tank corresponding to each ink color. The filled ink tank was set on a jig.

### (Discharge Stability)

The ink was continuously discharged from the nozzles of the recording head of the jig for 30 minutes under the condition that the amount of the discharged ink droplets was 8 pL (picoliters). The droplet amount of 8 pL corresponds to the droplet amount of ink discharged when printing an image having an image density of 100%. After the ink was discharged, the jig was left to stand for 10 minutes. After standing, the number of nozzles (non-discharge nozzles) from which ink was not discharged among the nozzles of the recording head of the jig was checked. The discharge stability of the ink was evaluated from the number of the non-discharge nozzles according to the following criteria. The evaluation results are shown in Table 4. The ink evaluated as A or B was determined to have good discharge stability, and the ink evaluated as C was determined to have poor discharge stability.

Evaluation A: The number of non-discharge nozzles is 0.
Evaluation B: The number of non-discharge nozzles is 1 or more and 3 or less.
Evaluation C: The number of non-discharge nozzles is 4 or more.

### (Evaluation of Friction Fastness)

An image having an image density of 100% was printed on a polyester fiber cloth (Tetronpongi fabric) using a jig under the condition that the amount of ink droplets discharged was 8 pL. Using a press machine (“Desktop Automatic Press machine AF-54TEN type” manufactured by Asahi Garment Machinery Co. Ltd.), heat treatment was performed on a printed polyester fiber cloth under conditions of a temperature of 180° C., a pressure of 0.20N/cm², and a processing time of 60 seconds. The polyester fiber cloth and the image were integrated by heat treatment to obtain an evaluation cloth. According to the drying test method described in JIS (Japanese Industrial Standard) L-0849 (Method for Testing Color Fastness to Rubbing), the degree of friction fastness of the evaluation cloth was determined. Among the grades from Grade 1 to Grade 5, the higher the numerical value of the grade (the closer to Grade 5), the better the friction fastness. From the grade of the friction fastness, the friction fastness was evaluated according to the following criteria. The evaluation results are shown in Table 4. An ink evaluated as A or B was determined to have good friction fastness, and an ink evaluated as C was determined to have poor friction fastness.

Evaluation A: The friction fastness is grade 4 or higher.
Evaluation B: The friction fastness is grade 3 or higher and lower than grade 4.
Evaluation C: The friction fastness is lower than grade 3.

TABLE 4

| | | Exam- | Exam- | Exam- | Exam- | Exam- | Exam- | Exam- | Exam- | Compar- | Compar- | Compar- | Compar- |
|---|---|---|---|---|---|---|---|---|---|---|---|---|---|
| | | ple 1 | ple 2 | ple 3 | ple 4 | ple 5 | ple 6 | ple 7 | ple 8 | ison 1 | ision 2 | ision 3 | ision 4 |
| Ink | | IA-1 | IA-2 | IA-3 | IA-4 | IA-5 | IA-6 | IA-7 | IA-8 | IB-1 | IB-2 | IB-3 | IB-4 |
| Emulsified dispersion | | DA-1 | DA-2 | DA-3 | DA-4 | DA-5 | DA-6 | DA-7 | DA-8 | DB-1 | DB-2 | DB-3 | DB-4 |
| Composite D [symbol] [nm] | | 150 | 120 | 100 | 120 | 150 | 120 | 150 | 150 | Not | Complete | 170 | 150 |
| | | | | | | | | | | emulsified | dissolution | | |
| Evaluation | Dispersion | B | B | A | B | B | B | B | | — | — | B | B |
| | state | | | | | | | | | | | | |
| | Ejection | B | B | B | B | B | B | B | B | — | — | B | B |
| | stability | | | | | | | | | | | | |
| | Friction | B | B | B | A | B | B | B | B | — | — | C | C |
| | fastness | | | | | | | | | | | | |

[symbol]

indicates data missing or illegible when filed

The meaning of each term in Table 4 will be described. “Composite D₅₀” refers to the volume median diameter (unit: nm) of the composite particles.

As described above, in the preparation of the emulsified dispersion (DB-1) contained in the ink (IB-1), the chip-shaped colored kneaded product was not emulsified and became a lumpy aggregate, and the fine composite particles (CB-1) were not formed. The “not emulsified” of the ink (IB-1) indicates that the volume median diameter of the composite particles (CB-1) could not be measured because the composite particles (CB-1) were not formed. In addition. “-” of the ink (IB-1) indicates that the evaluation of the ink (IB-1) was not performed because the composite particles (CB-1) were not formed.

As described above, in the preparation of the emulsified dispersion (DB-2) contained in the ink (IB-2), the chip-shaped colored kneaded product was completely dissolved and the fine composite particles (CB-2) were not formed. The “complete dissolution” of the ink (IB-2) indicates that the volume median diameter of the composite particles (CB-2) could not be measured because the composite particles (CB-2) were not formed. “-” of the ink (IB-2) indicates that the evaluation of the ink (IB-2) was not performed because the composite particles (CB-2) were not formed. The meaning of each term in Table 4 has been described above.

Here, each of the inks (IA-1) to (IA-8) had the following configuration. As shown in Table 4, each of the inks (IA-1) to (IA-8) contained the emulsified dispersions (DA-1) to (DA-8), respectively, and as shown in Table 2, each of the emulsified dispersions (DA-1) to (DA-8) contained the composite particles (CA-1) to (CA-8), respectively. As shown in Tables 1 and 2, the composite particles (more specifically, each of the composite particles (CA-1) to (CA-8)) contained in the inks (more specifically, each of the inks (IA-1) to (IA-8)) were particles of composites of polyester resins having sulfur-atom-containing polar groups (more specifically, one of the resins (A1) to (A4)) and dyes (more specifically, one of C. I. Disperse Blue 359, C. I. Disperse Red 60, and C. I. Disperse Yellow 54). As confirmed in the above <Measurement of glass transition point and melting point>, all of the resins (A1) to (A4) were non-crystalline polyester resins. As shown in Table 1, the resins (A1) to (A4) each had a first repeating unit, a second repeating unit, and a third repeating unit. As shown in Table 1, the first repeating unit ratios of the resins (A1) to (A4) were 1 mol % or more and 10 mol % or less. As shown in the “content” column of Table 2, the polyester resin ratio was 50% by mass or more and less than 100% by mass

As shown in Table 4, the evaluation of the dispersion state of the inks (IA-1) to (IA-8) was A or B, and the composite particles were favorably emulsified and dispersed in these inks. In addition, the evaluation of the discharge stability of the inks (IA-1) to (IA-8) was 13, and these inks were able to be favorably discharged from the nozzles of the recording head included in the inkjet recording apparatus. The evaluation of the friction fastness of the images formed using the inks (IA-1) to (IA-8) was A or B, and the friction fastness of the images formed using these inks was good.

As shown in Table 1, the resin (B1) used in the preparation of the composite particles (CB-1) contained in the ink (IB-1) did not have the first repeating unit. Therefore, as described above, in the preparation of the emulsified dispersion (DB-1) contained in the ink (IB-1), the chip-shaped colored kneaded product was not emulsified and the fine composite particles (CB-1) could not be formed.

As shown in Table 1, the first repeating unit ratio of the resin (B2) used in the preparation of the composite particles (CB-2) contained in the ink (IB-2) exceeded 10 mol %. Therefore, as described above, in the preparation of the emulsified dispersion (DB-2) contained in the ink (IB-2), the chip-shaped colored kneaded product was completely dissolved, and the fine composite particles (CB-2) could not be formed.

As shown in Table 2, in the composite particles (CB-3) contained in the ink (IB-3) and the composite particles (CB-4) contained in the ink (IB-4), the polyester resin ratio was less than 50% by mass. Therefore, as shown in Table 4, the evaluations of the friction fastness of the images formed using the inks (IB-3) and (IB-4) were C, and the friction fastness of the images formed using these inks were poor. This is considered to be because the polyester resin ratio was low and the composite particles were difficult to adhere to the recording medium (more specifically, polyester fiber cloth).

From the above, it is shown that the ink according to the present disclosure is excellent in dispersibility and discharge stability, and can print an image excellent in friction fastness. In addition, since the ink according to the present disclosure is a liquid at room temperature, the ink can be used in a normal inkjet recording apparatus which is not a hot melt type, a configuration for heating a recording head can be omitted, and the apparatus configuration can be simplified.

What is claimed is:

1. An inkjet ink comprising:
an aqueous medium and composite particles
wherein:
the composite particles are particles of a composite of a polyester resin having a sulfur atom-containing polar group and a dye, and
the polyester resin is a non-crystalline, and
the polyester resin has:
a first repeating unit derived from a polyvalent carboxylic acid having the sulfur atom-containing polar group:
a second repeating unit derived from a polyvalent carboxylic acid having no sulfur atom-containing polar group; and
a third repeating unit derived from a polyhydric alcohol,
wherein a content percentage of the first repeating unit relative to a total amount of the first repeating unit and the second repeating unit is 1 mol % or more and 10 mol % or less,
wherein a content percentage of the polyester resin relative to the composite particles is 50% by mass or more and less than 100% by mass.

2. The inkjet ink according to claim 1, wherein the dye is a disperse dye or an oil-soluble dye.

3. The inkjet ink according to claim 1, wherein the sulfur-atom-containing polar group is a sulfonic acid group or an alkali metal salt of a sulfonic acid group.

4. The inkjet ink according to claim 1, wherein the first repeating unit is a repeating unit derived from sodium 5-sulfoisophthalate.

5. The inkjet ink according to claim 1, wherein the second repeating unit is at least two of a repeating unit derived from a terephthalic acid, a repeating unit derived from an isophthalic acid, a repeating unit derived from a naphthalenedicarboxylic acid, and a repeating unit derived from an alkyl ester of these acids.

6. The inkjet ink according to claim 1, wherein the third repeating unit is a repeating unit derived from an ethylene glycol and a repeating unit derived from a bisphenol A propylene oxide adduct.

7. The inkjet ink according to claim 1, wherein a content of a repeating unit containing an aromatic hydrocarbon relative to the total amount of the first repeating unit, the second repeating unit, and the third repeating unit is 50 mol % or more.

8. The inkjet ink according to claim 1, wherein the composite particles have a volume median diameter of 20 nm or more and 300 nm or less.

9. The inkjet ink according to claim 1, further comprising a blocked isocyanate compound.

10. The inkjet ink according to claim 1, wherein the inkjet ink does not contain a pigment.
